(19) United States
(12) Patent Application Publication
(10) Pub. No.: US 2026/0212483 A1
(43) Pub. Date: Jul. 23, 2026

(54) FLAW ESTIMATION DEVICE

(71) Applicant: JVCKENWOOD Corporation, Kanagawa (JP)

(72) Inventor: Kazunori SHIODA, Yokohama-shi (JP)

(21) Appl. No.: 19/567,841

(22) Filed: Mar. 16, 2026

Related U.S. Application Data
(63) Continuation of application No. PCT/JP2024/038923, filed on Oct. 31, 2024.

(30) Foreign Application Priority Data
Oct. 31, 2023 (JP) 2023-186519

(51) Int. Cl. G06T 7/00; G01N 21/88; G06T 7/70

(52) U.S. Cl. CPC G06T 7/0004; G01N 21/8851; G06T 7/70; G01N 2021/8861; G06T 2207/10024; G06T 2207/20081; G06T 2207/30108

(57) ABSTRACT

A flaw estimation device estimates a position of a flaw of an estimation target from a non-polarized image of the estimation target, in which the non-polarized image is an RGB image that is a two-dimensional image not including polarization information. The flaw estimation device is trained by a training data set generated by a training data set generation device including an image acquisition unit configured to acquire a non-polarized image of a training target, a flaw position information acquisition unit configured to acquire position information of a flaw of the training target, and a training data set generation unit configured to generate the training data set by associating the non-polarized image and the position information of the flaw, which is estimated based on a polarized image of the training target.

### CROSS REFERENCE TO RELATED APPLICATION

Priority is claimed on Japanese Patent Application No. 2023-186519, the content of which is incorporated herein by reference.

### BACKGROUND

### Technical Field

The present invention relates to a flaw estimation device.

### Background Art

In the case of an appearance inspection that performs an inspection for color, flaws, foreign matter, or the like of a subject, in general, a camera suitable for the purpose of the inspection is used. For example, in an inspection for color of the subject, an RGB camera that performs imaging of a non-polarized visible light region can be used. Further, for example, a method that uses polarization to detect a flaw of the subject is known. Patent Document 1 discloses a method that inspects whether an optical disc has a scratch on the basis of reflected light reflected by the optical disc. With the use of the method described in Patent Document 1 and a polarization camera that images a polarization component, the inspection for a flaw of the subject can be performed. In this way, for example, in the case of inspecting for color and a flaw, both the RGB camera and the polarization camera are used.

### CITATION LIST

### Patent Document

[Patent Document 1] Japanese Patent No. 3154074

### SUMMARY

However, because two cameras are used, cost is increased compared to when one camera is used like normal imaging.

An aspect of the present embodiment is a flaw estimation device that estimates a position of a flaw of an estimation target from a non-polarized image of the estimation target, in which the non-polarized image is an RGB image that is a two-dimensional image not including polarization information, the flaw estimation device is trained by a training data set generated by a training data set generation device including an image acquisition unit configured to acquire a non-polarized image of a training target, a flaw position information acquisition unit configured to acquire position information of a flaw of the training target, and a training data set generation unit configured to generate the training data set by associating the non-polarized image and the position information of the flaw with each other, the position information of the flaw is information estimated on the basis of a polarized image of the training target, the polarized image is a polarized image including all polarization components obtained by processing polarized images in a plurality of directions, and the flaw position information of training data of the training data set is a binary image with the position of the flaw as white and a flawless position as black.

### BRIEF DESCRIPTION OF THE DRAWINGS

FIG. 1 is a diagram showing a configuration of a training data set generation system according to the present embodiment.

FIG. 2 is a diagram showing a configuration of a training data set generation device according to the present embodiment.

FIG. 3 is a diagram showing an example of a configuration of a camera according to the present embodiment.

FIG. 4 is a diagram showing an example of a configuration of the camera according to the present embodiment.

FIG. 5A is an example of a polarized image captured by the camera.

FIG. 5B is an example of an RGB image captured by the camera.

FIG. 6 is a DOLP image converted from the polarized image.

FIG. 7 is a diagram showing an example of training data generated by the training data set generation unit.

FIG. 8 is a flowchart illustrating an operation of the training data set generation system according to the present embodiment.

FIG. 9 is a diagram showing a configuration of an RGB image flaw estimation model generation device according to the present embodiment.

FIG. 10 is a flowchart illustrating an operation of the RGB image flaw estimation model generation device according to the present embodiment.

FIG. 11 is a diagram showing a configuration of a flaw estimation system according to the present embodiment.

FIG. 12 is a diagram showing a configuration of an RGB image flaw estimation device according to the present embodiment.

FIG. 13 is a flowchart illustrating an operation of the flaw estimation system according to the present embodiment.

### DETAILED DESCRIPTION

### System Overview

Hitherto, for example, an inspection system that inspects for color or a flaw of a product in a production line of a factory has become known. It is known that a polarization camera that can acquire a state of polarization on a surface of the product can detect the presence of a flaw on the surface of the product with high accuracy compared to an RGB camera that performs imaging without depending on polarization. As an example of an inspection system of the related art using the polarization camera, an inspection system that can inspect for color and a flaw of a product simultaneously by inspecting for color of the product on the basis of an image acquired by an RGB camera and inspecting for a flaw of the product on the basis of a polarized image acquired by a polarization camera is known.

According to the inspection system of the related art having the above-described configuration, it is possible to inspect for a color defect and a flaw defect of the product simultaneously and remove a defective product from the production line.

On the other hand, because the inspection system of the related art described above uses two kinds of cameras that are the RGB camera and the polarization camera, there is a problem in that a system configuration is complicated and the cost of the inspection system cannot be reduced.

Here, when a flaw can be detected on the basis of an image captured by the RGB camera with the same accuracy as when an image is acquired by the polarization camera, the polarization camera can be omitted from the inspection system.

In the following description, while a non-polarized image will be described as an RGB image that is a two-dimensional image including luminance information and color information, it is assumed that the non-polarized image also includes a luminance image (monochrome image) that is a two-dimensional image with only the luminance information without including the color information.

Accordingly, in the present embodiment, it is proposed that a correspondence relationship between a flaw of a product captured by a polarization camera and an image of a flawed part captured by an RGB camera is trained by machine learning or the like to detect the flaw on the basis of the image captured by the RGB camera with the same accuracy as when an image is captured by the polarization camera.

In performing machine learning, in general, it will be an issue how training data can be efficiently generated. In the present embodiment, training data is a polarized image of a training target (for example, a product) or position information of a flaw indicated by the polarized image.

In the present embodiment, a combination of a polarized image that is training data (or position information of a flaw indicated by the polarized image) and an RGB image captured by the RGB camera is referred to as a training data set.

Hereinafter, a functional configuration of each of a training data set generation system 1 that generates the training data set, an RGB image flaw estimation model generation device 20 that generates a flaw estimation model according to the RGB image on the basis of the training data set generated by the training data set generation system 1, and an RGB image flaw estimation device 30 that estimates a flaw on the basis of the flaw estimation model generated by the RGB image flaw estimation model generation device 20 will be described in this order.

### Training Data Set Generation

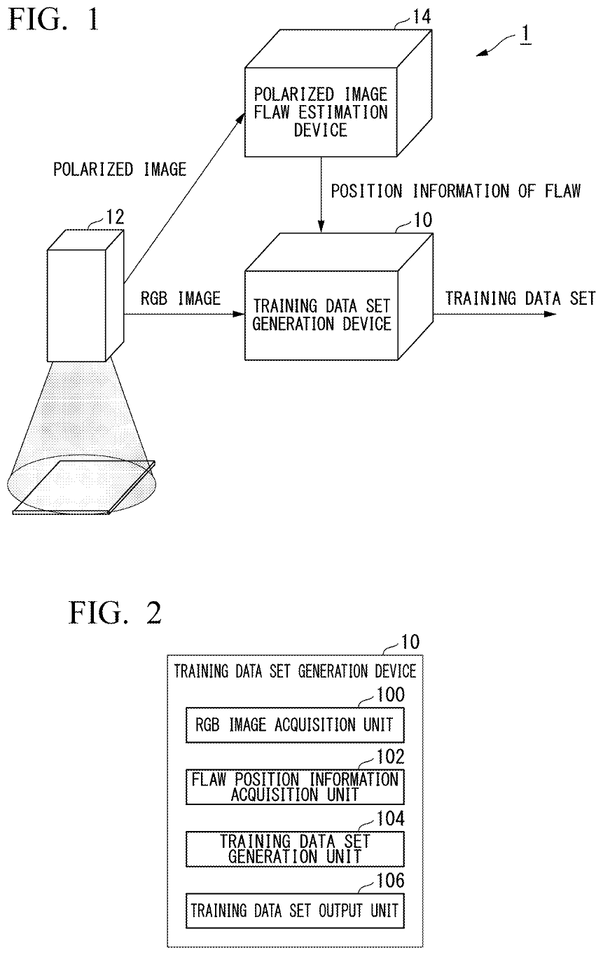

FIG. 1 is a diagram showing a configuration of the training data set generation system 1 according to the present embodiment. The training data set generation system 1 is a system that generates a data set in which an RGB image and position information of a flaw of a training target are associated with each other. The training data set generation system 1 includes a training data set generation device 10, a camera 12, and a polarized image flaw estimation device 14.

Here, the training target is, for example, a product that flows on a production line of a factory.

The training data set generation system 1 according to the present embodiment can be configured by adding the training data set generation device 10 to an existing inspection system of the related art.

The training data set generation device 10 generates a training data set on the basis of an RGB image and position information of a flaw for the same training target. FIG. 2 is a diagram showing a configuration of the training data set generation device 10 according to the present embodiment. The training data set generation device 10 includes an RGB image acquisition unit 100, a flaw position information acquisition unit 102, a training data set generation unit 104, and a training data set output unit 106.

The RGB image acquisition unit 100 acquires the RGB image of the training target from the camera 12.

The flaw position information acquisition unit 102 acquires the position information of the flaw of the training target from the polarized image flaw estimation device 14. The position information of the flaw is, for example, a position of a pixel indicating the flaw in the image. The position information of the flaw is coordinates in a predetermined reference system, for example. The position information of the flaw may be one or a plurality of coordinates specifying a position of the flaw or may be information of a figure or the like specifying a range of the flaw.

The training data set generation unit 104 generates a training data set by associating the RGB image of the training target acquired by the RGB image acquisition unit 100 and the position information of the flaw of the training target acquired by the flaw position information acquisition unit 102.

The camera 12 captures an RGB image and a polarized image of the training target. The camera 12 outputs the captured RGB image to the training data set generation device 10. The camera 12 outputs the captured polarized image to the polarized image flaw estimation device 14.

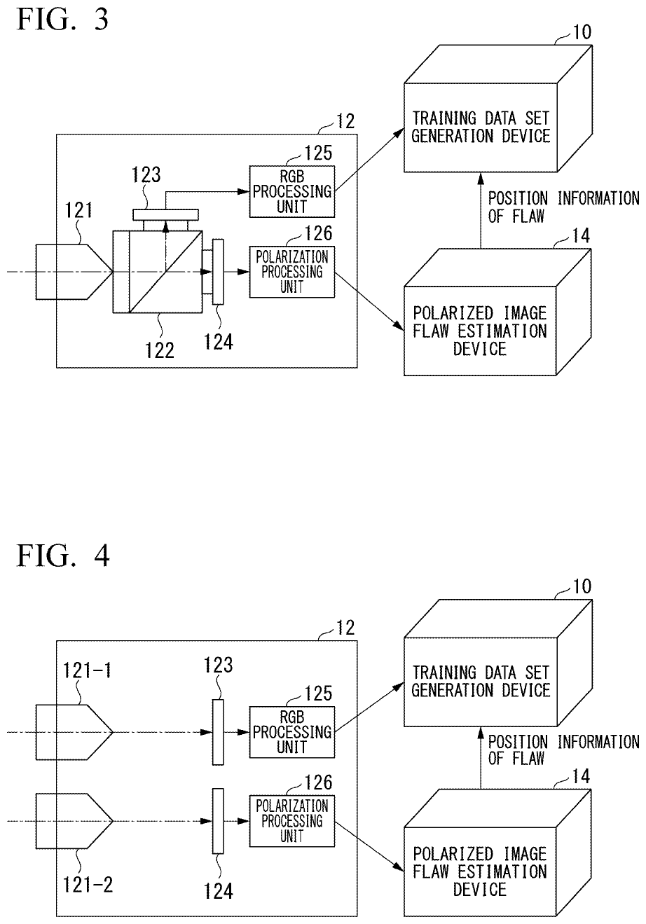

The camera 12 preferably captures the RGB image and the polarized image at the same optical axis. FIG. 3 is a diagram showing an example of a configuration of the camera 12 according to the present embodiment. The camera 12 includes a lens 121, a prism 122, an RGB sensor 123, a polarization sensor 124, an RGB processing unit 125, and a polarization processing unit 126. In the camera 12 shown in FIG. 3, light that enters the lens 121 is separated by the prism 122 and input to the RGB sensor 123 and the polarization sensor 124. The RGB sensor 123 detects red light, green light, and blue light of the input light, and the RGB processing unit 125 performs processing, so that an RGB image is generated.

The polarization sensor 124 detects polarized images in a plurality of directions of the input light. The polarization processing unit 126 processes the polarized images in the plurality of directions to a polarized image including all polarization direction components. The polarization sensor 124 has polarizers in a plurality of directions such as four directions on photodiodes of pixels and detects polarized images in a plurality of directions. The polarization processing unit 126 calculates all polarization components for each pixel by performing signal processing on the polarized images in the plurality of directions for each pixel and generates a polarized image including all polarization direction components. Accordingly, the polarization sensor 124 can detect a flaw of the training target even when a posture of the training target or a position of the flaw is not specified and there are various directions of polarization due to the flaw.

The camera 12 may capture an RGB image and a polarized image at close angles that can be substantially regarded as the same optical axis. FIG. 4 is a diagram showing an example of a configuration of the camera 12 according to the present embodiment. The camera 12 includes two lenses 121-1 and 121-2, an RGB sensor 123, a polarization sensor 124, an RGB processing unit 125, and a polarization processing unit 126. In FIG. 4, light that enters the lens 121-1 is input to the RGB sensor 123. In FIG. 4, light that enters the lens 121-2 is input to the polarization sensor 124. The operations of the RGB sensor 123, the polarization sensor 124, the RGB processing unit 125, and the polarization processing unit 126 in FIG. 4 are the same as the operations of the RGB sensor 123, the polarization sensor 124, the RGB processing unit 125, and the polarization processing unit 126 in FIG. 3.

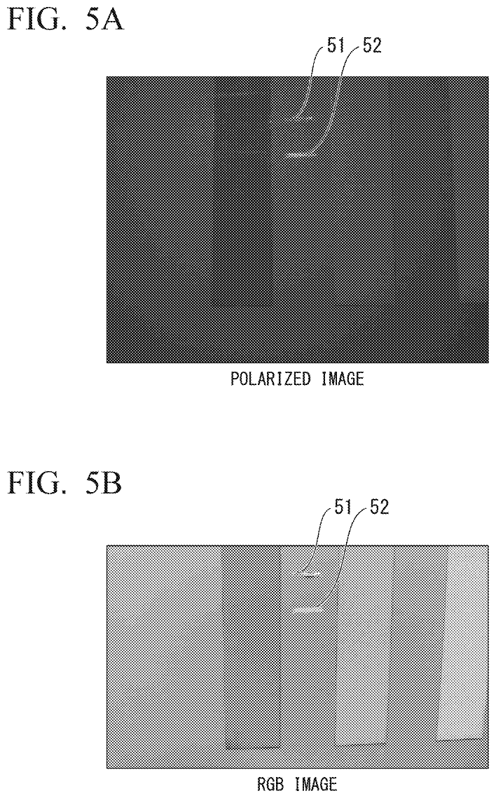

FIG. 5A is an example of a polarized image captured by the camera 12. FIG. 5B is an example of an RGB image captured by the camera 12. The polarized image captured by the camera 12 includes all polarization direction components. A region 51 is a flaw, and a region 52 is white painting modeled on a stain. In comparison of FIG. 5A and FIG. 5B, because the polarized image shown in FIG. 5A includes all polarization components, it is difficult to distinguish from the RGB image shown in FIG. 5B, and in the polarized image shown in FIG. 5A, it is difficult to discriminate between a flaw and something other than a flaw such as painting.

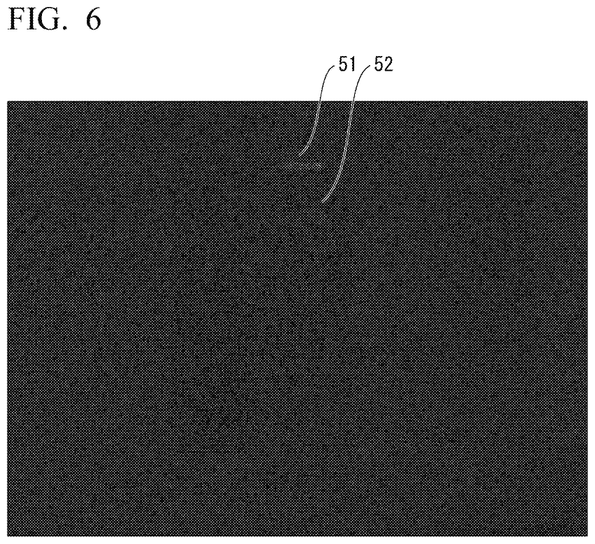

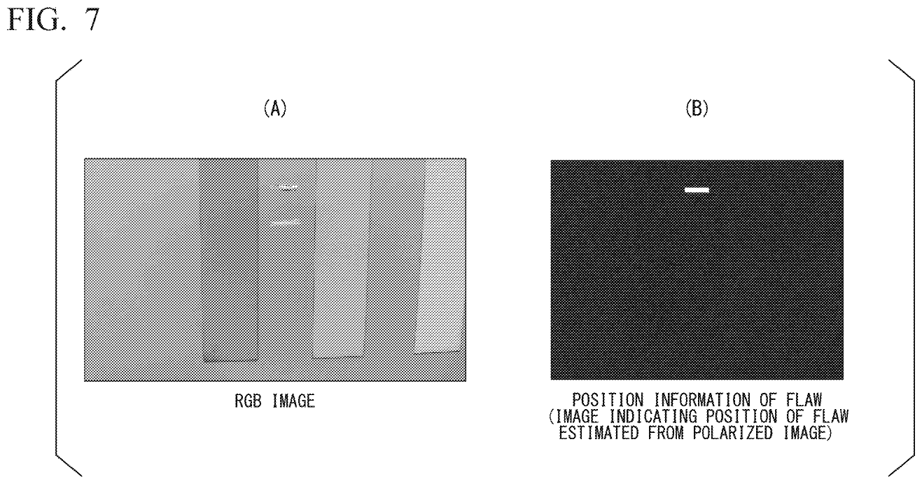

However, when image processing is performed to show only specific polarization information, the position of a flaw is easily estimated. FIG. 6 is the degree of linear polarization (DOLP) image converted from the polarized image shown in FIG. 5. Because the degree of polarization of light in a flaw is higher than that of painting, the difference between the region 51 that is a flaw and the region 52 that is white painting is clear in the DOLP image.

The polarized image flaw estimation device 14 acquires the polarized image from the camera 12. The polarized image flaw estimation device 14 estimates the position of the flaw on the basis of the polarized image. The polarized image flaw estimation device 14 outputs information on the estimated position of the flaw to the training data set generation device 10.

The polarized image flaw estimation device 14 estimates the position of the flaw on the basis of the polarized image using a model (hereinafter, called a polarized image flaw estimation model) that outputs position information of a flaw with a polarized image as an input. The polarized image flaw estimation model is a model that is generated by training using a data set in which a polarized image and position information of a flaw reflected in the polarized image are associated with each other.

A training method is not particularly limited, and the polarized image flaw estimation model is, for example, a neural network. The polarized image flaw estimation device 14 may be configured to estimate a position of a flaw from a polarized image including all polarization direction components as shown in FIG. 5 or may be configured to estimate a position of a flaw from a DOLP image as shown in FIG. 6.

FIG. 7 is a diagram showing an example of training data generated by the training data set generation unit. FIG. 7(A) is a diagram showing an example of training data (RGB image) generated by the training data set generation unit. FIG. 7(B) is a diagram showing an example of training data (position information of a flaw) generated by the training data set generation unit. The training data is data in which an RGB image of a training target and position information of a flaw of the training target are associated with each other and is data in which the RGB image shown in FIG. 7(A) and an image shown in FIG. 7(B) indicating a position of a flaw estimated from the polarized image are associated with each other, for example. The image indicating the position of the flaw estimated from the polarized image is a binary image with the position of the flaw as white and a flawless position as black, for example, as shown in FIG. 7(B).

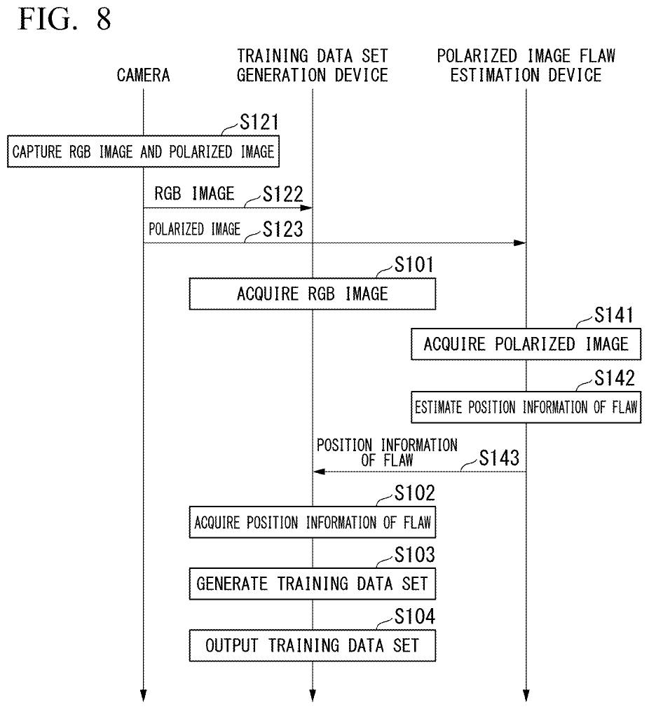

FIG. 8 is a flowchart illustrating an operation of the training data set generation system 1 according to the present embodiment. The camera 12 captures an RGB image and a polarized image of a training target (Step S121). The camera 12 outputs the RGB image to the training data set generation device 10 (Step S122). The camera 12 outputs the polarized image to the polarized image flaw estimation device 14 (Step S123). The training data set generation device 10 acquires the RGB image output from the camera 12 (Step S101). The polarized image flaw estimation device 14 acquires the polarized image output from the camera 12 (Step S141). The polarized image flaw estimation device 14 estimates position information of a flaw on the basis of the polarized image (Step S142). The polarized image flaw estimation device 14 outputs the position information of the flaw to the training data set generation device 10 (Step S143).

The training data set generation device 10 acquires the position information of the flaw output from the polarized image flaw estimation device 14 (Step S102). The training data set generation device 10 generates a training data set in which the RGB image and the position information of the flaw are associated with each other (Step S103). The training data set generation device 10 outputs the training data set (Step S104).

With the above, the training data set generation device 10 can generate the training data set in which the RGB image and the position information of the flaw are associated with each other.

The training data set generation system 1 can be created by adding a configuration (the RGB sensor 123 or the RGB processing unit 125) to acquire an RGB image and the training data set generation device 10 to the system of the related art that acquires a polarized image and estimates a position of a flaw from the polarized image. Further, by providing the training data set generation system 1 at a factory and imaging products and the like flowing on a line with the camera 12, a lot of training data can be generated. For this reason, the training data set generation system 1 can easily create a lot of data sets.

By capturing an RGB image and a polarized image at the same optical axis with the camera 12, a position of a flaw shown in the RGB image and a position of a flaw estimated from the polarized image in training data appear at the same position with no deviation. With this, it is possible to increase the accuracy of the estimation model that estimates the position of the flaw on the basis of the RGB image, using the generated training data set.

The polarized image flaw estimation device 14 may not be used, a person who observes a training target or an RGB image of the training target may input position information of a flaw to the training data set generation device 10, and the flaw position information acquisition unit 102 may acquire the position information of the flaw of the training target. In this case, the camera 12 may not capture a polarized image.

### Estimation Model Generation Device

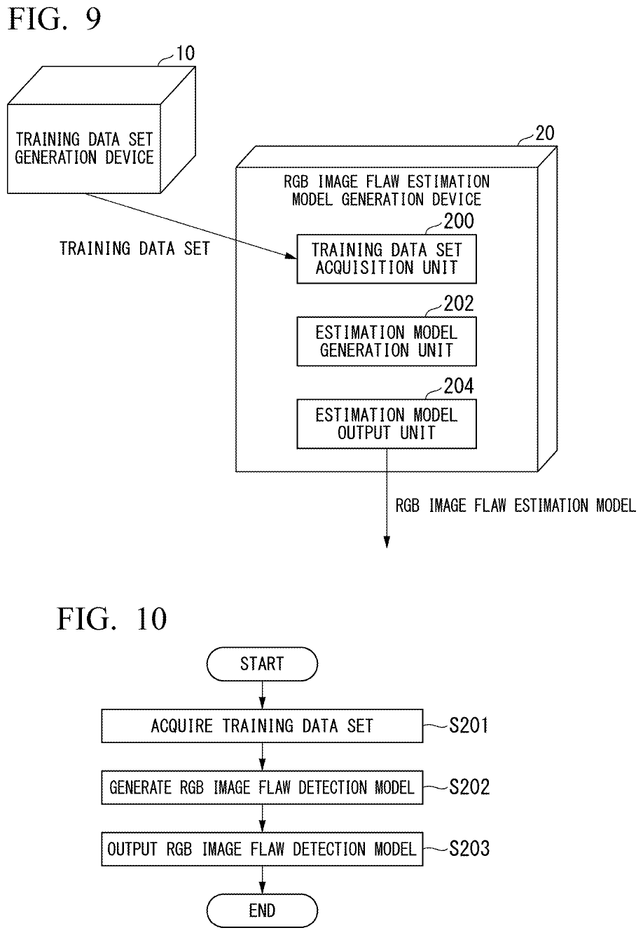

FIG. 9 is a diagram showing a configuration of the RGB image flaw estimation model generation device 20 according to the present embodiment. The RGB image flaw estimation model generation device 20 includes a training data set acquisition unit 200, an estimation model generation unit 202, and an estimation model output unit 204.

The training data set acquisition unit 200 acquires a training data set from the training data set generation device 10. The estimation model generation unit 202 generates an RGB image flaw estimation model by training using the training data set. The RGB image flaw estimation model is a model that estimates a position of a flaw with an RGB image as an input. A training method is not particularly limited, and the RGB image flaw estimation model is, for example, a neural network.

The estimation model output unit 204 outputs the generated RGB image flaw estimation model.

FIG. 10 is a flowchart illustrating an operation of the RGB image flaw estimation model generation device 20 according to the present embodiment. The training data set acquisition unit 200 acquires a training data set from the training data set generation device 10 (Step S201). The estimation model generation unit 202 generates an RGB image flaw estimation model by training using the training data set (Step S202). The estimation model output unit 204 outputs the RGB image flaw estimation model (Step S203).

### Flaw Estimation System

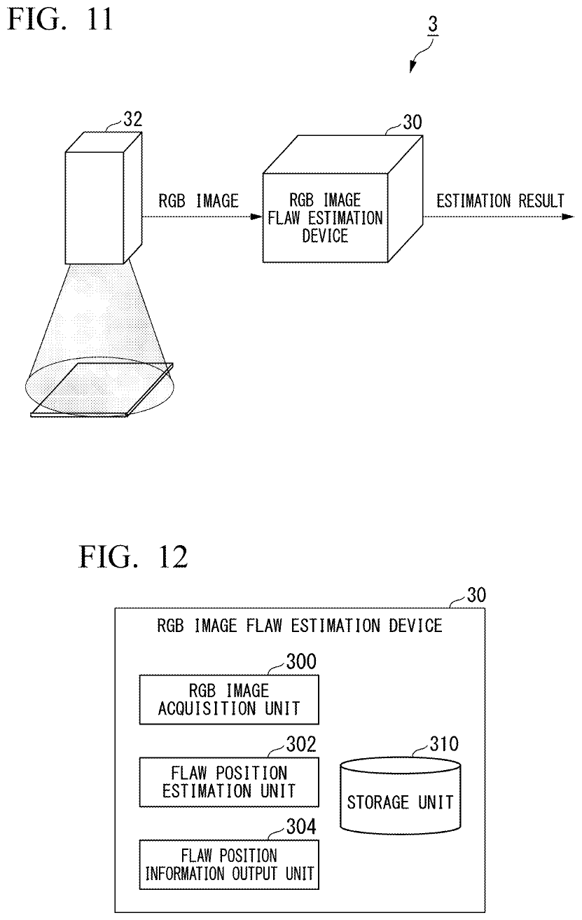

FIG. 11 is a diagram showing a configuration of a flaw estimation system 3 according to the present embodiment. The flaw estimation system 3 includes an RGB image flaw estimation device 30 and an RGB camera 32.

The RGB camera 32 images an estimation target to capture an RGB image. The RGB camera 32 outputs the captured RGB image to the RGB image flaw estimation device 30. The RGB image flaw estimation device 30 estimates a position of a flaw of the RGB image on the basis of the RGB image and outputs the position of the flaw. The flaw estimation system 3 is provided, for example, at a factory. The RGB camera 32 images a product or the like flowing on a line, and the RGB image flaw estimation device 30 detects a position of a flaw of the product or the like and outputs a detection result.

FIG. 12 is a diagram showing a configuration of the RGB image flaw estimation device 30 according to the present embodiment. The RGB image flaw estimation device 30 includes an RGB image acquisition unit 300, a flaw position estimation unit 302, a flaw position information output unit 304, and a storage unit 310. The storage unit 310 stores the RGB image flaw estimation model output from the RGB image flaw estimation model generation device 20.

The RGB image acquisition unit 300 acquires an RGB image from the RGB camera 32.

The flaw position estimation unit 302 estimates a position of a flaw on the basis of the RGB image using the RGB image flaw estimation model. The flaw position estimation unit 302 estimates the position of the flaw by inputting the RGB image to the RGB image flaw estimation model and causing the RGB image flaw estimation model to output an estimation result of the position of the flaw.

The flaw position information output unit 304 outputs information on the estimated position of the flaw.

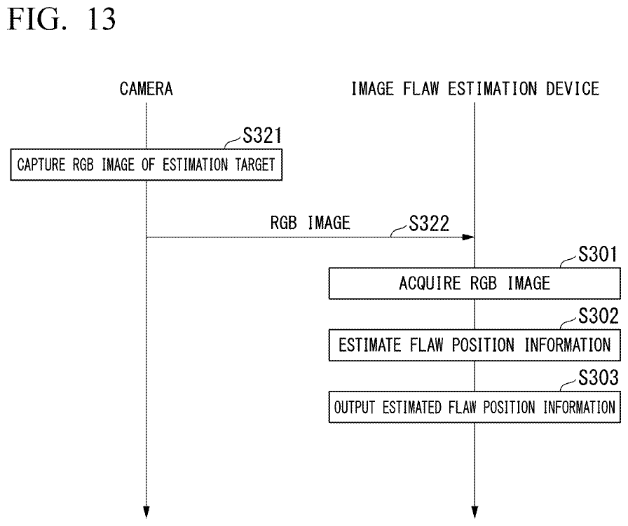

FIG. 13 is a flowchart illustrating an operation of the flaw estimation system 3 according to the present embodiment. The RGB camera 32 captures an RGB image of an estimation target (Step S321). The RGB camera 32 outputs the RGB image to the RGB image flaw estimation device 30 (Step S322).

The RGB image acquisition unit 300 acquires the RGB image from the RGB camera 32 (Step S301). The flaw position estimation unit 302 estimates a position of a flaw on the basis of the RGB image using the RGB image flaw estimation model (Step S302). The flaw position information output unit 304 outputs information on the estimated position of the flaw (Step S303).

With the above, the flaw estimation system 3 can estimate the position of the flaw of the estimation target on the basis of the RGB image. The flaw estimation system 3 can also inspect for color of the estimation target on the basis of the RGB image, in addition to estimating the position of the flaw of the estimation target on the basis of the RGB image. The flaw estimation system 3 can perform not only an inspection for color of the estimation target but also an inspection of a flaw only by capturing the RGB image.

That is, according to the present embodiment, it is possible to estimate a position of a flaw on the basis of a non-polarized image.

### Other Embodiments

Although one of embodiment of the invention has been described above in detail with reference to the drawings, a specific configuration is not limited to the above-described configuration, and various design changes and the like may be made without departing from the spirit and scope of the invention.

The processing of the training data set generation device 10, the polarized image flaw estimation device 14, the RGB image flaw estimation model generation device 20, or the RGB image flaw estimation device 30 in the above-described embodiment may be realized by software on a computer. In this case, the functions may be realized by recording a program for realizing the functions on a computer-readable recording medium, and reading and executing the program recorded on the recording medium in a computer system. The “computer system” stated herein includes an OS and hardware such as peripheral devices. The “computer-readable recording medium” refers to a portable medium such as a flexible disk, a magneto-optical disk, a ROM, or a CD-ROM or a storage device such as a hard disk embedded in the computer system. In addition, the “computer-readable recording medium” may include a medium that dynamically holds the program for a short time like a communication line when the program is transmitted via a network such as the Internet or a communication line such as a telephone line or a medium that holds the program for a given time like a volatile memory inside the computer system serving as a server or a client in that case. The above-described program may be a program for realizing a part of the functions described above, may be a program that can realize the functions described above in combination with a program already recorded in the computer system, or maybe a program that is realized using a programmable logic device such as a field programmable gate array (FPGA).

### EXPLANATION OF REFERENCES

1 Training data set generation system
10 Training data set generation device
100 RGB image acquisition unit
102 Flaw position information acquisition unit
104 Training data set generation unit
106 Training data set output unit
12 Camera
121 Lens
122 Prism
123 RGB sensor
124 Polarization sensor
125 RGB processing unit
126 Polarization processing unit
14 Polarized image flaw estimation device
20 RGB image flaw estimation model generation device
200 Training data set acquisition unit
202 Estimation model generation unit
204 Estimation model output unit
3 Flaw estimation system
30 RGB image flaw estimation device
300 RGB image acquisition unit
302 Flaw position estimation unit
304 Flaw position information output unit
310 Storage unit
32 RGB camera

What is claimed is:

1. A flaw estimation device that estimates a position of a flaw of an estimation target from a non-polarized image of the estimation target,
wherein the non-polarized image is an RGB image that is a two-dimensional image not including polarization information,
the flaw estimation device is trained by a training data set generated by a training data set generation device including
an image acquisition unit configured to acquire a non-polarized image of a training target,
a flaw position information acquisition unit configured to acquire position information of a flaw of the training target, and
a training data set generation unit configured to generate the training data set by associating the non-polarized image and the position information of the flaw with each other,
the position information of the flaw is information estimated on the basis of the polarized image of the training target, and the polarized image is a polarized image including all polarization components obtained by processing polarized images in a plurality of directions, and
the flaw position information of training data of the training data set is a binary image with the position of the flaw as white and a flawless position as black.

2. The flaw estimation device according to claim 1,
wherein the non-polarized image is a luminance image that is a two-dimensional image including luminance information or an RGB image that is a two-dimensional image further including color information.

3. The flaw estimation device according to claim 1,
wherein the non-polarized image and the polarized image are images captured substantially at the same optical axis.
